(19) United States
(12) Patent Application Publication
(10) Pub. No.: US 2014/0238741 A1
(43) Pub. Date: Aug. 28, 2014

(54) HERMETICALLY SEALED WIRE CONNECTOR ASSEMBLY AND METHOD OF MAKING SAME

(71) Applicant: DELPHI TECHNOLOGIES, INC., Troy, MI (US)

(72) Inventors: Steven WILLING, Encinitas, CA (US); Federico KELLENBERGER, Tecate, B.C. (MX); Eric J. SMOLL, Fontana, CA (US); Bao Q. LE, Santa Ana, CA (US)

(73) Assignee: DELPHI TECHNOLOGIES, INC., Troy, MI (US)

(21) Appl. No.: 14/271,701

(22) Filed: May 7, 2014

Related U.S. Application Data
(63) Continuation-in-part of application No. 13/757,201, filed on Feb. 1, 2013.
Application No. 13/757,201 is a continuation-in-part of application No. 13/423,325, filed on Mar. 19, 2012.

(51) Int. Cl. H01R 4/70; H01R 43/04; H01R 4/10

(52) U.S. Cl. CPC H01R 4/70; H01R 4/10; H01R 43/04
USPC 174/84 R; 29/868

(57) ABSTRACT

A wire connector assembly configured to provide a hermetic seal between two distinct environments and a method of constructing same is presented. The assembly includes insulated wire cables having ends that are spaced apart and joined by a wire splice element within a connector body, thereby interrupting a fluid leak path through the strands of the wire cables. The connector body formed of a fiberglass filled epoxide epoxy material may be over-molded the wire splice elements having a matte tin plated finish. A portion of connector body or the wire splice element may be disposed intermediate to the ends of the wire cables, providing an additional physical barrier to the fluid leak path. The materials selected and the shape of the wire splice elements are selected to mitigate the formation of microcracks between the connector body and splice elements that could allow the infiltration of gases through the connector assembly.

### CROSS-REFERENCE TO RELATED APPLICATION

This application is a continuation-in-part application and claims benefit under 35 U.S.C. §120 of U.S. patent application Ser. No. 13/757,201, filed Feb. 1, 2013, which is a continuation-in-part application and claims benefit under 35 U.S.C. §120 of U.S. patent application Ser. No. 13/423,325, filed Mar. 19, 2012, which claims benefit under 35 U.S.C. §119(e) of U.S. Provisional Patent Application No. 61/514,951, filed Aug. 4, 2011, the entire disclosure of each of which is hereby incorporated herein by reference.

### TECHNICAL FIELD OF INVENTION

The invention relates to a wire connector assembly, more particularly, a wire feed-through connector assembly containing provisions that allow use of the wire connector assembly in gaseous environments.

### BACKGROUND OF INVENTION

Some electrical applications require submersion of a wire connector assembly in a fluid environment. One example of a wire connector assembly includes wire conductors formed with an inner core that has individual wire strands covered by an insulative outer covering. A portion of the wire conductors are stripped free of the insulation covering and the stripped areas are subsequently tinned with solder. Tinning the wire strands fuses the wire strands together by forming a coat of solder on the wire strands resulting in a single, solid core wire connection. The tinned solid core wire connection creates a dam that acts as a leakage barrier to impede fluid flow into, and through the individual wire strands. The tinned solid core connections of the wire conductors are then over-molded with an electrically nonconductive material to form a molded connector body. The molded connector body is subsequently attached to a support structure within the fluid environment. This wire connector assembly design has several drawbacks. One drawback is that the solder may wick into the wire stands so that a tinned portion of the wire strands extend beyond a boundary of the molded connector body. This causes a portion of the wire conductor to be mechanically stiffer than the remaining wire conductor which reduces the flexibility and increases a bend radius of the wire conductor at the molded connector boundary which may inhibit a tight routing path desired in some electrical applications.

Other wire connector configurations such as those shown in U.S. Pat. No. 6,501,025 and U.S. Patent Publication Nos. 2013/032395 and 2013/140082 show a wire connector assembly wherein the wires on one side of the connector body are physically separated from but electrically connected to the wires on the other side of the connector body by a splice element. Differences in the thermal coefficients of expansion between the connector body material and the splice element material as well as lack of adhesion of the connector body material may allow microcracks to develop between the connector body and the splice elements. While these microcracks may still allow these wire connector assemblies to maintain a fluid tight seal, they provide a path through the connector body for gases that prevent the wire connector assembly from providing a gas tight, or hermetic, seal.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### SUMMARY OF THE INVENTION

In accordance with one embodiment of this invention, a wire connector assembly is provided. The wire connector assembly includes a connector body formed of a dielectric material, such as fiberglass filled epoxide epoxy material, and a plurality of wire cables formed of an electrically conductive inner core surrounded by an electrically insulative outer covering. Each wire cable has an outer covering end portion that is removed to expose an inner core end portion. Each inner core comprises a plurality of wire strands. The wire connector assembly also includes a wire splice element that is formed of a conductive material, such as matte tin plated brass material, and electrically and mechanically joins at least two inner core end portions. The two inner core end portions are axially spaced apart. The material forming the connector body chemically bonds with the surface layer of the wire splice element. The connector body encloses said wire splice element and sealably engages each outer covering of the plurality of wire cables. The plurality of wire cables, the wire splice element, and the connector body provide a hermetically sealed electrically conductive path through the wire connector assembly.

A portion of the connector body is disposed intermediate to the two inner core end portions to provide a barrier to a gas infiltrating the inner core of one of the plurality of wire cables. Alternatively, a portion of the wire splice element is disposed intermediate to the two inner core end portions to provide a barrier to a gas infiltrating the inner core of one of the plurality of wire cables.

In accordance with another embodiment of this invention, a method to fabricate a wire connector assembly having a connector body formed of a fiberglass filled epoxide epoxy material, a plurality of wire cables, and a wire splice element is provided. The method includes the steps of providing a plurality of wire cables, wherein the plurality of wire cables are formed of an electrically conductive inner core surrounded by an electrically insulative outer covering and providing a wire splice element formed of a matte tin plated brass material. The method further includes the steps of removing the outer covering from an end of each wire cable to expose the inner cores of the plurality of wire cables and electrically and mechanically attaching the end of each wire cable to the wire splice element to form a wire arrangement. The method also includes the steps of heating a mold, inserting the wire arrangement into a fixture, placing the fixture into the mold, and injecting a fiberglass filled epoxide epoxy material into the mold to surround at least a portion of the wire arrangement containing the wire splice element to form the wire connector assembly. The method additionally includes the step of cooling the epoxy material to a solid state, thereby chemically bonding the epoxy material forming the connector body to the matte tin plating on the wire splice element and forming the connector body. The connector body encloses said wire splice element and sealably engages the outer covering of the plurality of wire cables. The mold may be heated to a temperature between 149° C. and 177° C. The method may optionally include the step of heating the fixture to a temperature between 149° C. and 177° C. prior to placing the fixture into the mold. The fiberglass filled epoxide epoxy material may be injected into the mold at a temperature between 174° C. and 179° C.

Further features and advantages of the invention will appear more clearly on a reading of the following detailed description of the preferred embodiment of the invention, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 illustrates a wire connector assembly partially disposed within a fuel tank of a lawn mower in accordance with a first embodiment;

FIG. 2 is a perspective view of a wire connector assembly in accordance with a first embodiment;

FIG. 3 is a perspective view of a wire arrangement used in the wire connector assembly of FIG. 2 in accordance with a first embodiment;

FIG. 4 is a cut away view of the wire connector assembly of FIG. 2 in accordance with a first embodiment;

FIG. 5a is a side view of a wire splice element used in the wire connector assembly of FIG. 2 in accordance with a first embodiment;

FIG. 5b is a top view of a wire splice element used in the wire connector assembly of FIG. 2 in accordance with a first embodiment;

FIG. 6 is a block diagram of a process of aligning wire arrangements in a fixture that is positioned in a mold to produce the wire connector assembly of FIG. 2 in accordance with a first embodiment;

FIG. 7 is an illustration of an outer covering pulling away from a connector body and exposing wire strands of the wire arrangement, in accordance with the prior art;

FIG. 8 is a cut away view of the wire connector assembly in accordance with a second embodiment;

FIG. 9 is a perspective view of a wire splice element used in a wire connector assembly in accordance with a third embodiment;

FIG. 10 is a cut away view of the wire connector assembly in accordance with a third embodiment;

FIG. 11 is a cut away view of a wire splice element of the wire connector assembly of FIG. 10 in accordance with a third embodiment;

FIG. 12 is a perspective view of a wire splice element of the wire connector assembly of FIG. 10 in accordance with a third embodiment; and

FIG. 13 is a flow chart of a process of forming the wire connector assembly in accordance with any of the embodiments.

### DETAILED DESCRIPTION OF INVENTION

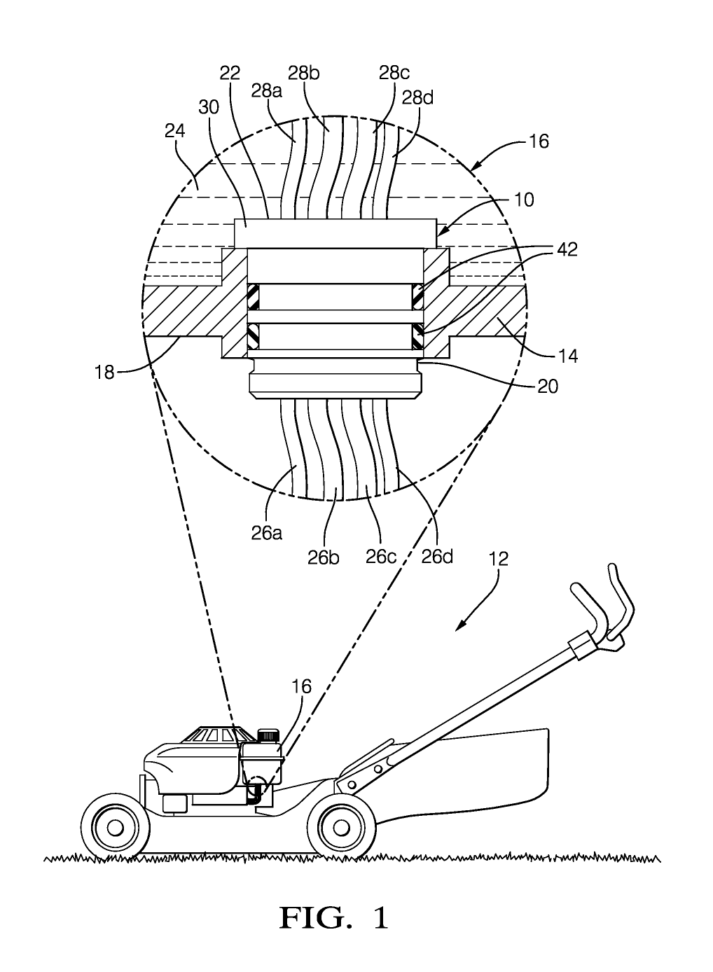

FIG. 1 illustrates a non-limiting example of a wire feed-through connector assembly 10, hereinafter the assembly 10, installed on a lawn mower 12. Assembly 10 is located within a wall 14, or bulkhead 14, of a fuel tank 16 of lawn mower 12 and electrically connects an electrical component (not shown) disposed in fuel tank 16, such as a fuel level sensor, to another electrical component (not shown), such as a fuel gauge, external to fuel tank 16. Thus, assembly 10 as disposed on lawn mower 12 is exposed to a first gaseous environment 18 (e.g. air) along a first portion 20 of assembly 10 while a second portion 22 of assembly 10 is exposed to a second gaseous environment 24 (e.g. gasoline vapors). When the second portion 22 of assembly 10 is surrounded by gasoline vapors 24, assembly 10 is advantageously resistant to leakage of gasoline vapors 24 through the assembly 10. Other embodiments of the assembly 10 may be envisioned that are designed to be used in applications where the first portion 20 of the assembly 10 is exposed to a fluid environment while the second portions 22 is exposed to a gaseous environment or vice versa. Alternatively, both the first portion 20 and the second portion 22 could be exposed to a fluid environment. The assembly 10 may also be used in application where there is a pressure differential between the first portion 20 and the second portion 22 and provide a hermetic seal, for example in a fuel tank 16 that is pressurized relative to the outside air 18.

When used in the fuel tank 16 shown in FIG. 1, the first plurality of wire cables 26a-d and the first portion 20 of assembly 10 are exposed to air 18. The second plurality of wire cables 28a-d and the second portion 22 of the assembly 10 are exposed gasoline vapors 24. Electrical signals are conducted by the first plurality of wire cables 26a-d though the air 18, or first gaseous environment 18, to a plurality of wire splice elements (not shown) within the connector body 30 and to the second plurality of wire cables 28a-d that conducts the electrical signals though the gasoline vapors 24 that is a second gaseous environment 24 distinctly different from the first gaseous environment 18.

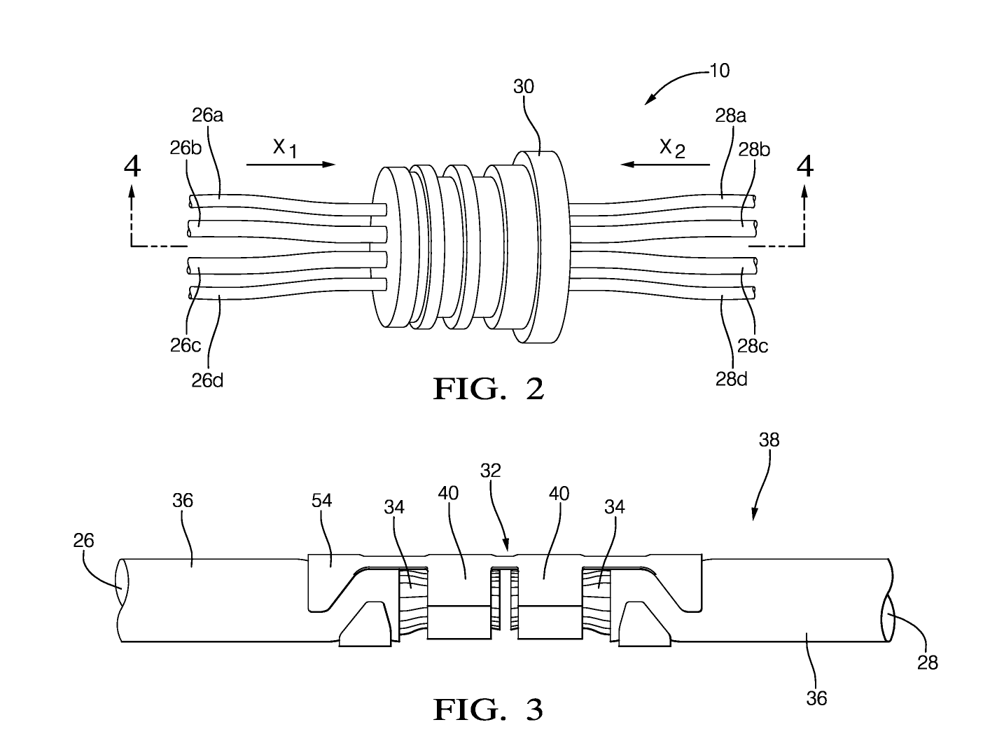

As shown in the non-limiting example of FIG. 2, the first plurality of wire cables 26 a-d that enter a connector body 30 of assembly 10 and a second plurality of wire cables 28a-d that respectively exit the connector body 30 of assembly 10.

As shown in the non-limiting example of FIG. 3, the first wire cable 26 is mechanically and electrically joined to the second wire cable 28 by a wire splice element 32. Each wire cable 26, 28 is formed of an electrically conductive inner core 34 surrounded by an electrically insulative outer covering 36. Each wire cable 26, 28 has an outer covering 36 end portion removed to expose an inner core 34 end portion. Each inner core 34 is made up of a plurality of wire strands formed of a conductive material, such as a copper alloy or aluminum alloy. Multiple wire strands advantageously allow the wire cables 26, 28 to bend at an interface with connector body 30 without wire cable breakage in contrast to the tinned wire strands in wire feed-through connector assemblies cited in the Background as previously described herein. The outer covering may be formed of a dielectric material, such as polyvinylchloride (PVC), polytetrafluoroethylene (PTFE), or another suitable insulative material well known to those skilled in the art.

A first inner core 34 end portion of one of the first plurality of wire cables 26 is electrically and mechanically joined to a second inner core 34 end portion of one of the second of wire cables 28 by a wire splice element 32 to form a wire arrangement 38. In the illustrated example, the first inner core 34 end portion and the second inner core 34 end portion are axially spaced apart. Alternatively, other embodiments of the assembly 10 may be envisioned in which the first inner core 34 end portion and the second inner core 34 end portion are non-axially spaced apart, for example the end portions may be axially offset from each other or the end portions may be arranged perpendicular to each other.

In this non-limiting example, the wire splice element 32 defines a plurality of wire crimp wings 40 that are configured to be mechanically and electrically connected to the first inner core 34 end portion and the second inner core 34 end portion. The plurality of wire crimp wings 40 are spaced apart so that when the first and second inner core 34 portion are joined to the wire splice element 32, the first inner core 34 end portion and the second inner core 34 end portion are spaced apart. Without subscribing to any particular theory of operation, fluids may enter the wire cables 26, 28 through tears or openings in the outer covering 36 and flow though spaces or voids between the wire strands of the inner core 34. Because the ends of the wire cables 26, 28 are spaced apart, or separated, gas entering the first wire cable 26 cannot directly continue its flow path to enter the second wire cable 28. Crimping the wire splice element to the first and second inner core fuses the wire strands of each inner core to form a hermetic barrier—i.e. air can no longer pass between the strands. The gap between the first and second wire cables 26, 28 provided by the wire splice element 32 forms a physical barrier between the inner cores 34. The hermetic fusing in the crimp also secures the end of the wire to the splice element 32. This provides two benefits over soldering the inner core 34. First it eliminates solder migration that could brittle the first and second wire cable 26, 28. Second, the crimp can be calibrated for the gauge of wire used for the first and second wire cable 26, 28. This will provide more consistent results versus soldering which could form air gaps between strands of the inner cores 34 or have significant variation from part to part.

The design of wire splice elements 32 having wire crimp wings 40 and the methods used to mechanically and electrically attach wire splice elements 32 to wire cables 26, 28 are well known to those skilled in the art. While this example illustrates a wire arrangement 38 having two wire cables 26, 28 joined by a single wire splice element 32, other embodiments may be envisioned wherein three or more wire cables are joined by a single wire splice element 32.

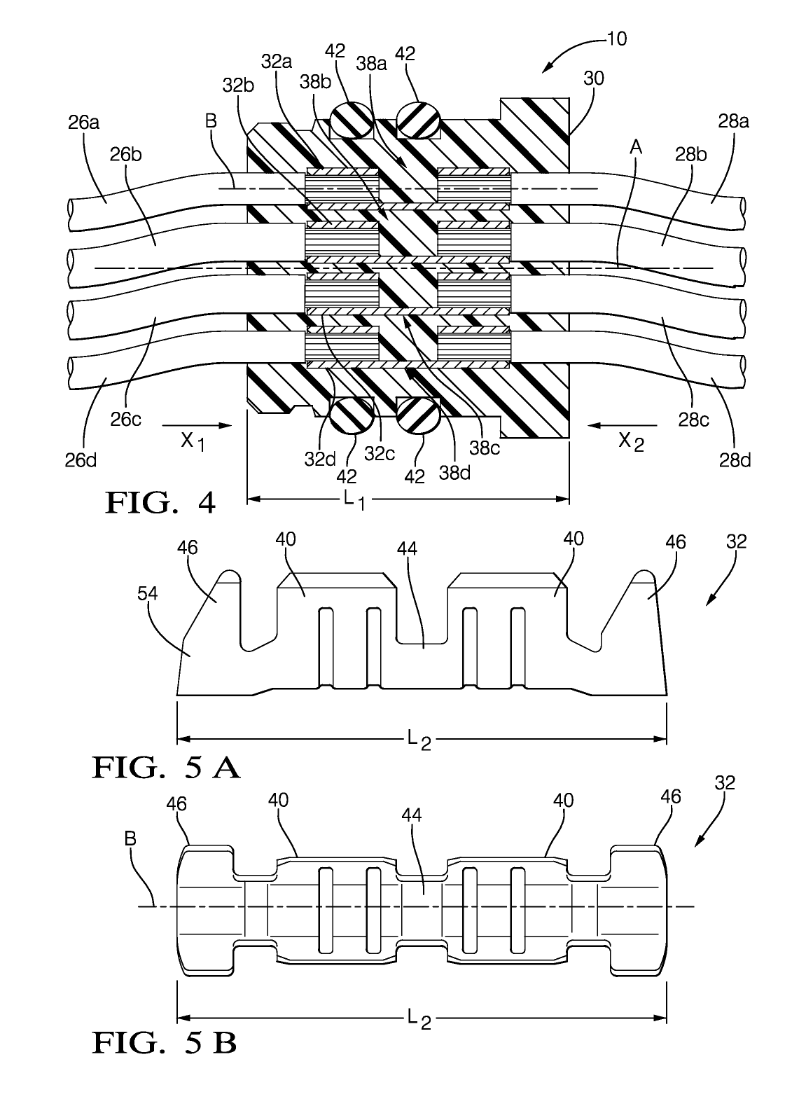

As shown in the non-limiting example of FIG. 4, the assembly 10 includes a plurality of wire arrangements 38a-d disposed within a connector body 30 formed of a dielectric material. The connector body 30 encloses the plurality of wire splice elements 32a-d and sealably engages each outer covering 34 of the plurality of the wire cables 26a-d, 28a-d. In this non-limiting example, the connector body 30 of the assembly 10 is sealably attached to the wall 14 of the fuel tank 16 using O-ring seals 42 disposed in grooves in the connector body 30. As shown in FIG. 4, a portion of the connector body 30 is disposed intermediate to the spaced apart first inner core 34 end portion and the second inner core 34 end portion. The portion of the connector body 30 that is disposed intermediate to the inner core 34 end portions will further inhibit gas from flowing from the first wire cable 26 into the second wire cable 28 by forming a physical barrier between the first and second inner core ends.

The connector body 30 may be formed of a fiberglass filled epoxide epoxy material that chemically bonds with the outer covering 36 of the wire cables 26, 28 and further seals the assembly 10 against gas entering the assembly 10. An example of such a thermoset epoxy material is EPIALL 1908-1 produced by Sumitomo Bakelite North America, Inc. of Manchester, Conn. The epoxy-based material may provide more robust performance in an application where the assembly 10 will be exposed to chemicals, e.g. hydrocarbons, because the epoxy-based material is less likely to soften or chemically break down over a time period when disposed these in these types of applications.

The wire connector assembly 10 may be useful in the motorized transportation industry such as electrically connecting fuel level sensors in fuel tank applications, or in other industries like chemical processing, or oil and gas exploration where electrical connections must cross a boundary of two different environments. Flame retardant and/or low toxicity plastic materials may be utilized to construct the connector body 30 when the assembly 10 is used for aerospace applications.

As illustrated in the non-limiting example of FIG. 4, the connector body 30 has a length L, disposed along longitudinal axis A of connector body 30. The first plurality of wire cables 26a-d and the second plurality of wire cables 28a-d axially extend away from connector body 30 in opposing directions to respectively electrically connect with other electrical circuits and/or electrical devices (not shown). The first plurality of wire cables 26a-d join with connector body 30 from a first direction X₁ and the second plurality of wire cables 28a-d join with connector body 30 from a second direction X₂ opposite first direction X₁.

The wire arrangements 38a-d are axially disposed within the connector body 30 and include wire splice elements 32a-d respectively disposed in connector body 30. Wire splice elements 32a-d are formed from an electrically-conductive material, such as C36000 H02 brass. The electrically-conductive material may be electroplated with a matte tin plating 54 having a thickness between 0.005 and 0.009 millimeters thick. Copper underplating between the brass material and the tin plating may be desired to mitigate zinc migration from the brass to the tin plating layer. The brass material may be annealed for two hours at a temperature of 510° C. to soften the material so that the wire crimp wings 40 will conform to the wire cables 26, 28 when they are crimped to the ends of the wire cables 26, 28.

The first inner core 34 end portions of the first plurality of wire cables 26 a-d are disposed in one end of the wire splice elements 32a-d and are in intimate contact with the wire crimp wings 40 and the second inner core 34 end portions of the second plurality of wire cables 28a-d are disposed in the opposite end of the wire splice elements 32a-d and are in intimate contact with the wire crimp wings 40. The first inner core 34 end portions, the second inner core 34 end portions, and the wire splice elements 32a-d are enclosed by connector body 30. Wire splice elements 32a-d are further spaced apart one-to-another in a direction perpendicular to axis A within connector body 30 being spaced apart by portions of connector body 30, as best illustrated in FIG. 4. Accordingly, each wire arrangement 38 a-d in the plurality of wire arrangements 38a-d is electrically independent from the other wire arrangements 38 a-d when the wire splice elements 32 a-d are disposed within the connector body 30. While the example of the assembly 10 having wire arrangements 38a-d with an axial configuration is illustrated, embodiments of the assembly 10 with wire arrangements having non-axial configuration may also be envisioned

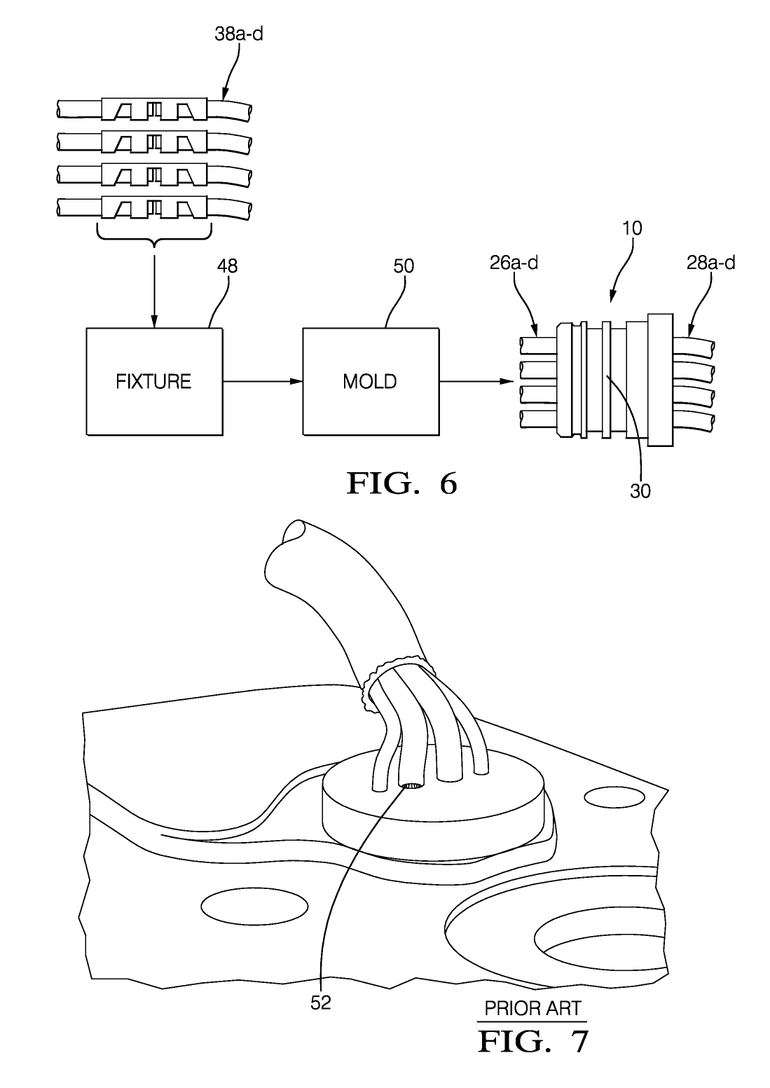

FIGS. 5a and 5b illustrate a non-limiting example of a wire splice element 32. The wire splice element 32 defines an axis B along a length L₂ of wire splice element 32. Length L₂ is less than length L, of the connector body 30. Axis B is typically parallel with axis A when wire splice element 32 is disposed in wire connector assembly 10 with other wire splice elements 32, as best illustrated in FIG. 4. A single wire splice element 32 is shown removed from the wire arrangement 38 of FIG. 3. The wire splice element 32 defines a pair of wire crimp wings 40 that are configured to mechanically and electrically connect the wire splice element 32 to the first inner core 34 end portion and the second inner core 34 end portion. The pair of wire crimp wings 40 is axially spaced apart from each other and the wire splice element 32 defines a connecting portion 44 intermediate to the pair of crimp wings. When the wire crimp wings 40 are closed over the inner core 34 ends, the connecting portion 44 will remain open. The wire splice element 32 also defines a pair of insulation crimp wings 46 that are configured to mechanically secure the outer covering 36 of the first wire cable 26 and the outer covering 36 of the second wire cable 28 to the wire splice element 32. The insulation crimp wings 46 are distinct from the wire crimp wings 40 and are disposed distal to the wire splice device 32. The wire splice device 32 may be formed by stamping and bending a sheet of conductive material using methods well known to those skilled in the art.

The connector body 30 may preferably be formed by molding the dielectric material around the wire arrangements 38. When the dielectric material is injected or poured in a fluid form into a mold 50 containing the wire arrangements 38, the dielectric material may flow into the open connecting portion 44 and after the dielectric material hardens into a solid form, a portion of the connector body 30 is disposed intermediate to the inner core 34 end portions.

Referring to FIG. 6, wire arrangements 38 a-c are arranged in a fixture 48 prior to the fixture 48 being moved to a mold 50 wherein connector body 30 is molded around the wire arrangements 38a-c. The fixture 48 may be formed from a steel or aluminum material.

The examples of the assembly 10 illustrate a configuration wherein the wire arrangements 38 are side-by-side. Alternatively, embodiments of the assembly 10 with other configurations of wire arrangements 38 may be envisioned. This may include, but is not limited to, an array of wire arrangements 38 within the connector body 30. One array may include wire arrangements 38 arrayed in rows and columns. An alternative array may have a staggered row arrangement. Alternatively, the assembly 10 may contain a single wire arrangement 38.

Mitigating the formation of microcracks between the connector body 30 and the wire splice element 32 is desired to provide a hermitic seal. The electrical connector assembly 10 contains several features that mitigate the formation of microcracks. Without subscribing to any particular theory of operation, the epoxy material chemically bonds to the matte tin plating 54 of the wire splice element 32 as well as the outer covering 36 of the wire cables 26, 28 thus inhibiting the formation of microcracks along the interface between the connected body material and the wire splice element 32. Other combinations of materials beside matte tin plating and epoxide epoxy may be chosen as long as the surface layers of each material provide a strong chemical bond between them. The linear coefficient of thermal expansion (LCTE) of the epoxy material forming the connector body 30 and the conductive material forming the wire splice element 32 is substantially equal, thus minimizing thermally induced strain that could cause microcracks. As used herein, substantially equal linear coefficient of thermal expansion means that the difference between the LCTE of the epoxy material forming the connector body 30 and the LCTE of the conductive material forming the wire splice element 32 is ±20×10⁻⁶/° C. The outer surface of the wire splice element 32 also includes discontinuous surfaces that diminish the propagation of microcracks along the outer surface of the wire splice element 32.

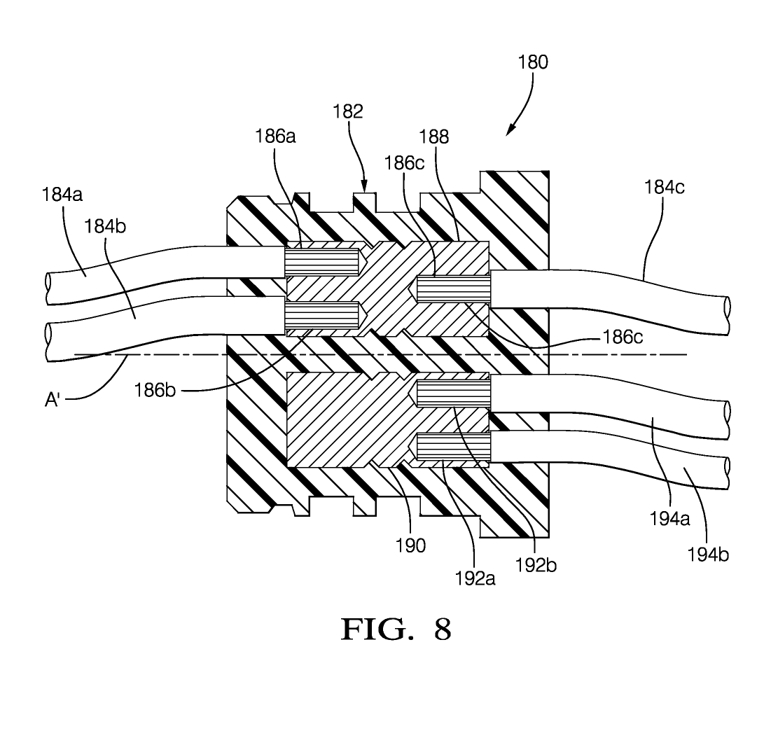

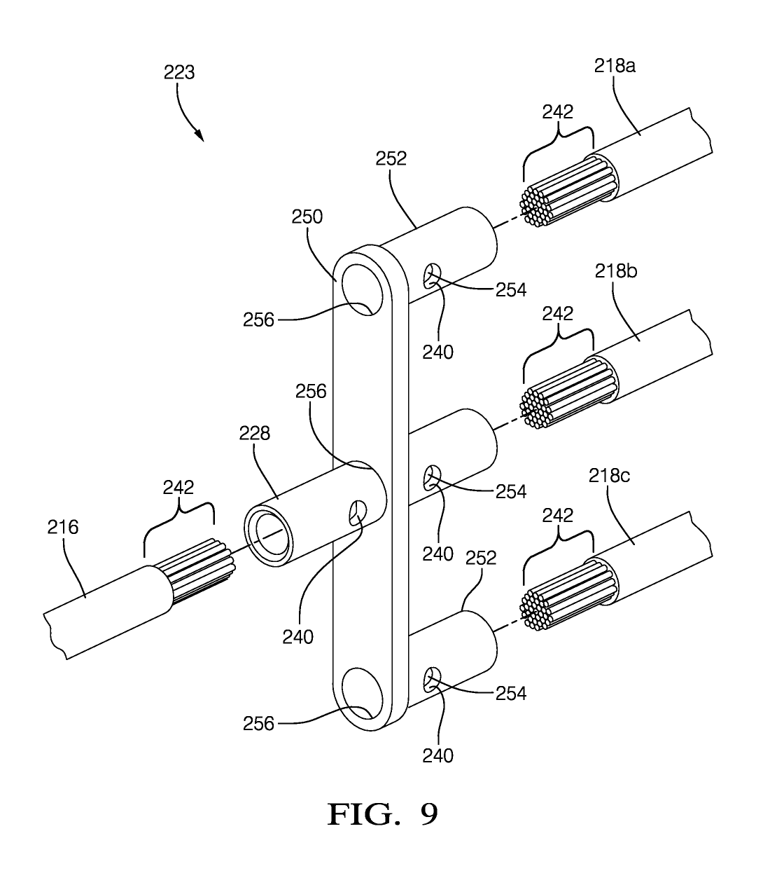

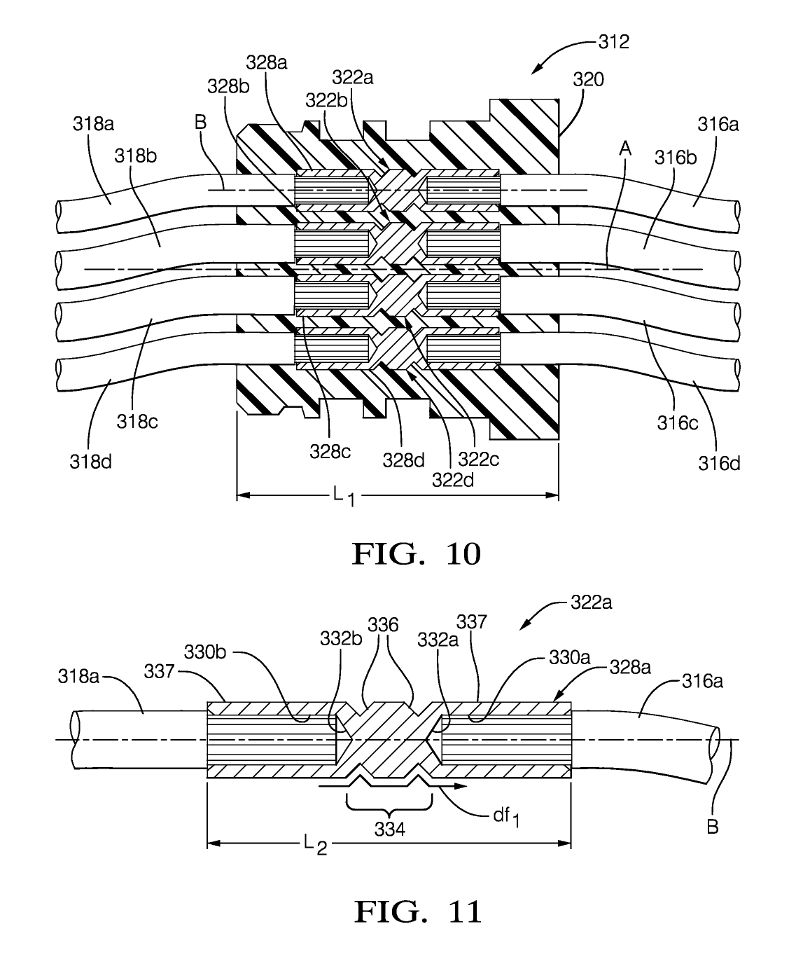

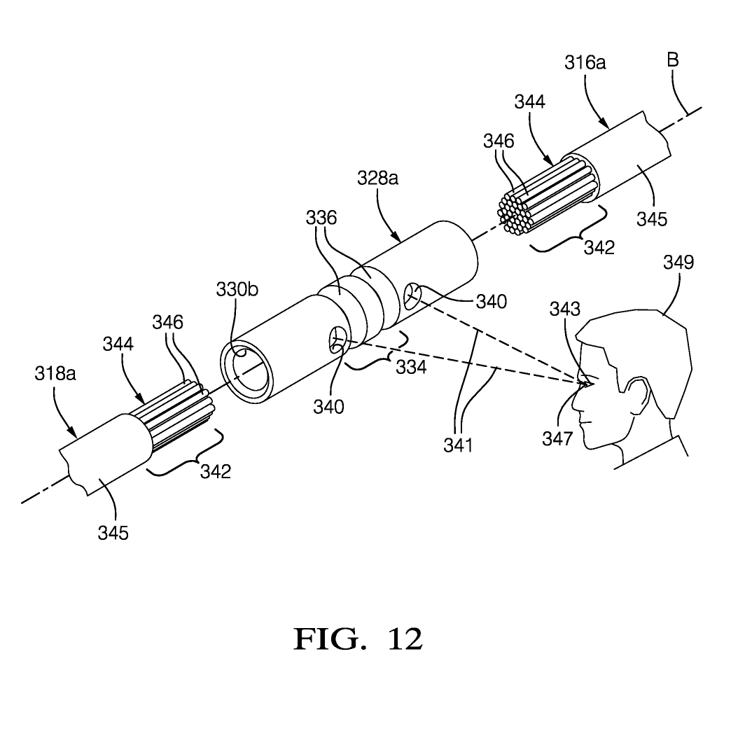

FIGS. 8-12 illustrate an alternative embodiment of the connector assembly wherein the wire splice element has a solid body disposed between the ends of the wire cables and a discontinuous outer surface.

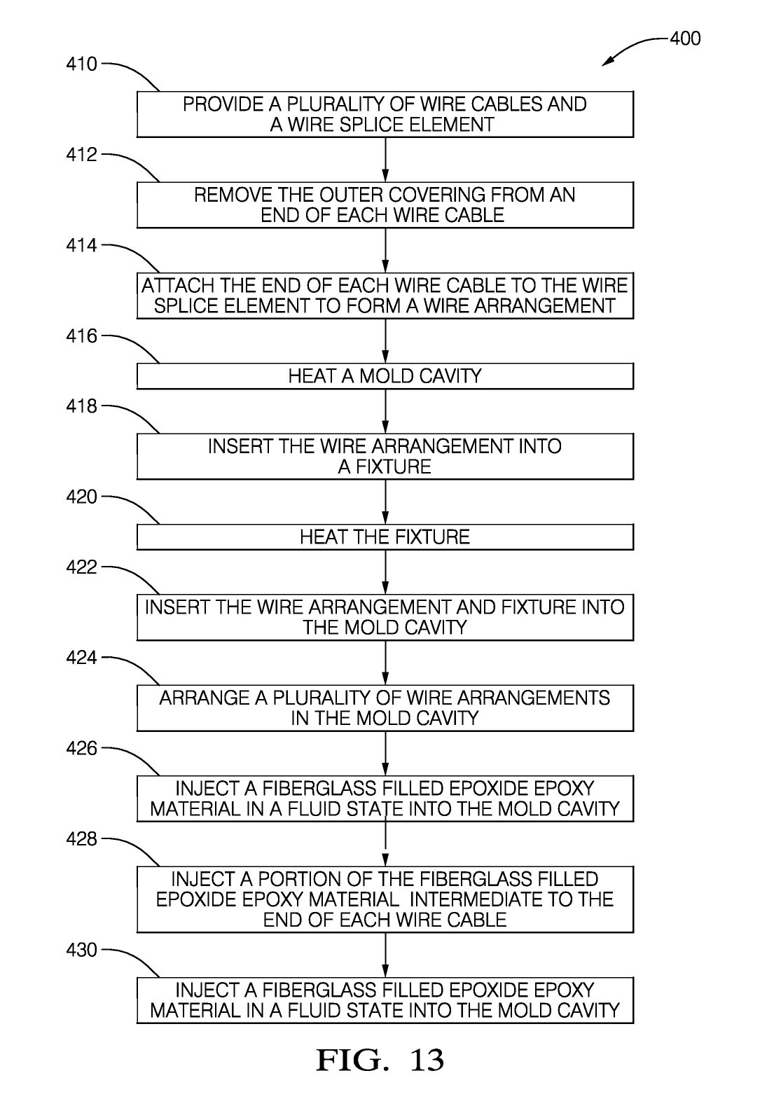

FIG. 13 illustrates a non-limiting method 300 of fabricating a wire connector assembly 10 having a connector body 30 formed of a fiberglass filled epoxide epoxy material, a plurality of wire cables 26, 28 formed of an electrically conductive inner core 34 surrounded by an electrically insulative outer covering, each wire cable 26, 28 having an outer covering end portion removed to expose an inner core 34 end portion, wherein each inner core 34 comprises a plurality of wire strands, and a wire splice element 32 formed of a matte tin plated brass material electrically and mechanically joining at least two inner core end portions. The epoxy material forming the connector body 30 chemically bonds with the matte tin plating 54 on the wire splice element 32. The two inner core end portions are axially spaced apart. The connector body 30 encloses the wire splice element 32 and sealably engages each outer covering 36 of the plurality of wire cables 26, 28. The method 300 may include the following steps.

Step 310, PROVIDE A PLURALITY OF WIRE CABLES AND A WIRE SPLICE ELEMENT, includes providing a plurality of wire cables 26.28 and a wire splice element 32. The plurality of wire cables 26, 28 are formed of an electrically conductive inner core 34 surrounded by an electrically insulative outer covering 36. The wire splice element 32 may define a plurality of wire crimp wings 40 configured to mechanically and electrically attach the wire splice element 32 to the inner core 34 of the wire cables 26, 28. The wire crimp wings 40 may be spaced apart from each other. The wire splice element 32 may also define a plurality of insulation crimp wings 46 configured to retain the outer covering. Crimping the plurality of insulation crimp wings 46 to the outer covering 36 of the wire cables 26, 28 may prevent the outer covering 36 from shifting or pulling back from the wire ends and may ensure that the insulation does not “pull back” 52 and expose the wire strands of the inner core 34 at the surface of the assembly 10 as shown in FIG. 7. The plurality of insulation crimp wings 46 may be distinct from the plurality of wire crimp wings 40. The wire splice element 32 is formed from an electrically-conductive material, such as C36000 H02 brass. The wire splice element 32 is electroplated with a matte tin plating 54 having a thickness between 0.005 and 0.009 millimeters thick.

Step 312, REMOVE THE OUTER COVERING FROM AN END OF EACH WIRE CABLE, includes removing the outer covering 36 from an end of each wire cable 26, 28 to expose the inner cores 34 of the plurality of wire cables 26, 28 by cutting away a portion of the outer covering 36.

Step 314, ATTACH THE END OF EACH WIRE CABLE TO THE WIRE SPLICE ELEMENT TO FORM A WIRE ARRANGEMENT, includes electrically and mechanically attaching the end of each wire cable 26, 28 to the wire splice element 32 to form a wire arrangement 38. At least one wire arrangement 38 is formed when the exposed ends of the inner metallic core 34 of the wire cables 26, 28 are electrically and mechanically attached to wire splice element 32.

STEP 316, HEAT A MOLD includes pre-heating a mold 50 configured to form a connector body 30 prior to injecting a molding material into the mold 50 with a device such as an injection molding machine. The mold 50 may be preheated to a temperature between 149° C. (300° F.) and 177° C. (350° F.) when a fiberglass filled epoxide epoxy material, such as EPIALL 1908-1 is injected into the mold 50 to form the connector body 30.

STEP 318, INSERT THE WIRE ARRANGEMENT INTO A FIXTURE, includes inserting the wire arrangement 38 into a fixture 48 that is configured to locate the wire arrangement 38 within the mold 50.

STEP 320, HEAT THE FIXTURE, is an optional step which includes preheating the fixture 48 prior to placing the fixture 48 into the mold 50. The mold 50 may be preheated to a temperature between 149° C. (300° F.) and 177° C. (350° F.) when a fiberglass filled epoxide epoxy material, such as EPIALL 1908-1 is injected into the mold 50 to form the connector body 30. Preheating the fixture 48 helps to avoid problems caused by localized accelerated cooling of the epoxy material around the fixture 48 as the epoxy material is injected into the mold 50. This localized cooling could weaken the chemical bond between the matte tin plating 54 on the wire splice element 32 and the epoxy material that could permit microcracks between them to form more easily. The localized cooling could also cause problems in the flow of the epoxy material within the mold 50.

Step 322, INSERT THE WIRE ARRANGEMENT AND FIXTURE INTO THE MOLD, includes inserting the wire arrangement 38 and fixture 48 into the mold 50.

Step 324, ARRANGE A PLURALITY OF WIRE ARRANGEMENTS IN THE MOLD, is an optional step which includes arranging a plurality of wire arrangements 38 a-c in the mold 50 so that the plurality of wire arrangements 38, a-c are electrically independent one-to-another. The plurality of wire arrangements 38 a-c may be placed into the fixture 48 to hold plurality of wire arrangements 38 a-c in place before being placed into the mold 50 as shown in FIG. 6.

Step 326, INJECT A FIBERGLASS FILLED EPOXIDE EPOXY MATERIAL IN A FLUID STATE INTO THE MOLD, includes injecting a fiberglass filled epoxide epoxy material, such as EPIALL 1908-1, in a fluid state into the mold 50 using an injection molding machine to surround at least a portion of the wire arrangement 38 containing the wire splice element 32 to form the wire connector assembly 10. The fiberglass filled epoxide epoxy material may be injected into the mold 50 at a temperature between 174° C. (345° F.) and 179° C. (355° F.).

STEP 328, INJECT A PORTION OF THE FIBERGLASS FILLED EPOXIDE EPOXY MATERIAL INTERMEDIATE TO THE END OF EACH WIRE CABLE, is an optional step which includes injecting a portion of the fiberglass filled epoxide epoxy material that forms the connector body 30 into the connecting portion 44 of the wire splice element 32 intermediate to the end of each wire cable 26, 28 to provide a barrier to a gas infiltrating the inner core 34 of one of the plurality of wire cables 26, 28.

Step 330, HARDEN THE FIBERGLASS FILLED EPOXIDE EPOXY MATERIAL TO A SOLID STATE, includes hardening the fiberglass filled epoxide epoxy material to a solid state, thereby forming a connector body 30, such as by cooling the epoxy material.

Accordingly, a wire feed-through connector assembly 10 that is configured to provide a hermetic seal between different gaseous environments and a method 300 of constructing a wire feed-through connector assembly 10 is provided. The assembly 10 provides electrical conductivity of the wire cables 26, 28 end-to-end through the connector body 30 of the assembly 10 in gaseous environments, fluid environments, or a combination of these environments. The assembly 10 inhibits gas leakage through the wire strands of the inner core 34 of the wire cables 26, 28 because the ends of the wire cables 26, 28 are spaced apart and joined by a wire splice element 32, forming a physical barrier to gas continuing a path through the assembly 10. Further, a portion of the connector body 30 is disposed between the ends of the wire cables 26, 28, providing an additional physical barrier to a gas leak path through the assembly 10. The assembly 10 uses no solder in its construction, thus, there is no undesirable wicking of solder into portions of the wire cables 26, 28 outside the connector body 30. The insulation crimp wings 46 secure the ends of the outer covering, preventing pull back of the outer covering that may result in exposed wire stands near the first portion 20 or the second portion 22 of the connector body 30. The epoxy material used to form the connector body 30 adheres to the matte tin plated finish 54 of the wire splice elements 32 and forms a strong chemical and mechanical bond between the connector body 30 and the wire splice element 32 mitigating the formation of microcracks that could provide a leak path through the connector assembly 10. The similarity in the coefficients of thermal expansion between the epoxy material and the brass material forming the wire splice element 32 and the discontinuous surfaces of the wire splice element 32 also serve to mitigate the formation of microcracks.

While this invention has been described in terms of the preferred embodiments thereof, it is not intended to be so limited, but rather only to the extent set forth in the claims that follow. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

We claim:

1. A wire connector assembly, comprising:
a connector body formed of a dielectric material;
a plurality of wire cables formed of an electrically conductive inner core surrounded by an electrically insulative outer covering, each wire cable having an outer covering end portion removed to expose an inner core end portion, wherein each inner core comprises a plurality of wire strands; and
a wire splice element formed of conductive material electrically and mechanically joining at least two inner core end portions, wherein a surface layer of the dielectric material forming the connector body chemically bonds with a surface layer of the conductive material forming the wire splice element, wherein the at least two inner core end portions are axially spaced apart, and wherein the connector body encloses said wire splice element and sealably engages each outer covering of the plurality of wire cables.

2. A wire connector assembly, wherein the dielectric material is a fiberglass filled epoxide epoxy material and the conductive material is a matte tin plated brass material.

3. The wire connector assembly according to claim 2, wherein the thickness of the matte tin plating is between 0.005 and 0.009 millimeters thick.

4. The wire connector assembly according to claim 2, wherein the coefficient of thermal expansion of the epoxy material is substantially equal to the coefficient of thermal expansion of the matte tin plated brass material.

5. The wire connector assembly according to claim 1, wherein the plurality of wire cables, the wire splice element, and the connector body provide a hermetically sealed electrically conductive path through the wire connector assembly.

6. The wire connector assembly according to claim 5, wherein a portion of the connector body is disposed intermediate to the at least two inner core end portions to provide a barrier to a gas infiltrating the inner core of one of the plurality of wire cables.

7. The wire connector assembly according to claim 5, wherein a portion of the wire splice element is disposed intermediate to the at least two inner core end portions to provide a barrier to a gas infiltrating the inner core of one of the plurality of wire cables.

8. A method to fabricate a wire connector assembly having a connector body formed of a fiberglass filled epoxide epoxy material, a plurality of wire cables, and a wire splice element, said method comprising the steps of:
providing a plurality of wire cables, wherein the plurality of wire cables are formed of an electrically conductive inner core surrounded by an electrically insulative outer covering;
providing a wire splice element formed of a matte tin plated brass material;
removing the outer covering from an end of each wire cable to expose the inner cores of the plurality of wire cables;
electrically and mechanically attaching the end of each wire cable to the wire splice element to form a wire arrangement;
heating a mold;
inserting the wire arrangement into a fixture;
placing the fixture into the mold;
injecting a fiberglass filled epoxide epoxy material into the mold to surround at least a portion of the wire arrangement containing the wire splice element to form the wire connector assembly; and
cooling the epoxy material to a solid state, thereby chemically bonding the epoxy material forming the connector body to the matte tin plating on the wire splice element and forming the connector body, wherein the connector body encloses said wire splice element and sealably engages the outer covering of the plurality of wire cables.

9. The method according to claim 8, wherein the mold is heated to a temperature between 149° C. and 177° C.

10. The method according to claim 8, wherein the fiberglass filled epoxide epoxy material is injected into the mold at a temperature between 174° C. and 179° C.

11. The method according to claim 8, wherein the method further includes the step of heating the fixture to a temperature between 149° C. and 177° C. prior to placing the fixture into the mold.

12. The method according to claim 8, wherein the plurality of wire cables, the wire splice element, and the connector body provide a hermetically sealed electrically conductive path through the wire connector assembly.

13. The method according to claim 8, wherein a portion of the epoxy material is disposed intermediate to at least two inner core end portions to provide a barrier to a gas infiltrating an inner core of one of the plurality of wire cables.

14. The method according to claim 8, wherein a portion of the wire splice element is disposed intermediate to at least two inner core end portions to provide a barrier to a gas infiltrating an inner core of one of the plurality of wire cables.

15. The method according to claim 8, wherein the thickness of the matte tin plating is between 0.005 and 0.009 millimeters thick.

16. The method according to claim 8, wherein the coefficient of thermal expansion of the epoxy material is substantially equal to the coefficient of thermal expansion of the matte tin plated brass material.
